(19) United States
(12) Patent Application Publication
(10) Pub. No.: US 2009/0101735 A1
(43) Pub. Date: Apr. 23, 2009

(54) Manually Connected Nozzle Assembly

(76) Inventors: Sean Morgan, Victoria (AU); Stuart Morgan, Victoria (AU)

Correspondence Address: EDWIN D. SCHINDLER, FIVE HIRSCH AVENUE, P.O. BOX 966, CORAM, NY, 11727-0966, US

(21) Appl. No.: 11/914,621

(22) PCT Filed: May 16, 2006
(86) PCT No.: PCT/AU2006/000648

§ 371 Date: Nov. 10, 2008

(30) Foreign Application Priority Data
May 16, 2005 (AU) 2005902496

(51) Int. Cl. B05B 1/00

(52) U.S. Cl. 239/596; 239/602; 239/587.1

(57) ABSTRACT

A manually constructed nozzle assembly includes a first component in a fixed engagement with a spray pipe. The first component is a base component and has a device for manual engagement with a second component, which is a cap component, so that a shower disc is able to be compressively held between the first and second components. Each of the first and second components has a central aperture, so that a shower nipple is able to extend into the spray pipe, when assembled.

### TECHNICAL AREA

This invention relates to the area of spray nozzles for use with fluids which are contaminated with particulate matter and in particular for use where white water or process water and the like are recycled and used for spraying applications.

### BACKGROUND TO THE INVENTION

Traditionally in the paper industry, and other such industries, particulate contaminated fluids such as white water and process water and the like are recycled and used for spraying applications. It is therefore desirable to use a spray nozzle system which reduces the likelihood of, or prevents blocking of, the nozzle orifice by this particulate matter.

A commonly accepted nozzle system utilises a pressed disc shaped nozzle, with a convex nipple which contains an orifice, and which protrudes up into and past the internal diameter of the spray pipe it is mounted to. By this means any particulate or sediment cannot readily pass into the orifice due to its higher position in the pipe.

It is also customary for the pipe to contain a longitudinal brush system that can rotate and sweep the interior of the pipe and make ready contact with the protruding orifice nipple. Thus particulate matter can be swept from a blocked nozzle by a machine operator by turning a valve type wheel at the end of the pipe or header.

Typically with such a system there is a requirement that the shower disc be mounted on a low profile mounting socket system to ensure that the thin disc nipple does in fact protrude into the pipe. However due to the fact that the spray pattern is generated far inside the pipe at the end of the orifice nipple, in instances where a wider spray pattern is required it is necessary that this mounting socket is also of a significant diameter. The low profile and significant diameter of the mounting system ensures that the spray pattern is not fouled or disrupted.

This system must also allow for a sealing gasket to ensure that the orifice disc seals against the low profile pipe socket which is usually welded into place. The achievement of the above desired criteria for a mounting system results in significant restriction in the designs which can be used.

A universally accepted retaining socket system has traditionally been a low profile, large diameter threaded socket with an internal sealing face for a sealing washer which then receives the shower disc nipple and is secured via a male threaded screw in plug type retaining ring which typically has a broached hexagonal internal socket, significant enough in diameter to clear the spray while allowing for a tool to engage it and thereby applying significant torque to secure the shower disc and form a seal with the gasket.

These securing systems require tools in order to effect assembly and isassembly and are awkward and cumbersome to handle. Difficulties arise both in inserting the orifice disc and seal into the inverted header pipe socket. Both the disc and seal may start to fall out as the operator tries to insert the retaining plug, the latter having a fine thread pitch which makes it difficult to commence thread engagement, and at the same time hold the nozzle in the correct spraying plane position until it is finally secured.

### OUTLINE OF THE INVENTION

It is an object of the invention to simplify the assembly procedure for the insertion and removal of the shower discs such that no tools are required and the shower disc can remain in the retaining cap retained by its own seal right up to the moment of actual assembly such that the nozzle is maintained in its correct spray plane and any possibility of the nozzle falling out during assembly is eliminated.

The invention is a nozzle system having a first component in fixed engagement with a spray pipe, said first base component being provided with means to engage manually with a second cap component such that a shower disc is held compressively between these two components, each of which is provided with a central aperture, the arrangement being such that a shower disc nipple extends into the pipe when assembled.

It is preferred that the base component be welded to the spray pipe. It may alternatively be preferred that it be retained on the pipe by means of spring clips or cable ties or other means.

It is further preferred that the base component be provided with a plurality of lugs which can engage with complementary receptors inside the cap component.

While the invention may exhibit any number of lugs it is preferred that three such lugs be provided on each base component in a triangulated arrangement.

It is further preferred that the dimensions of the lugs and receptors be such that the nozzle system can only be assembled in one orientation.

It is further preferred that an O ring be provided within the cap component to provide compression between the base and cap causing the nozzle system to lock when the cap is twisted onto the base by hand.

In order that the invention may be more readily understood we shall describe by way of non limiting example a specific embodiment thereof.

### BRIEF DESCRIPTION OF THE DRAWING FIGURES

FIG. 1 Shows an exploded diagram of the components of the nozzle system from the cap end of the nozzle;

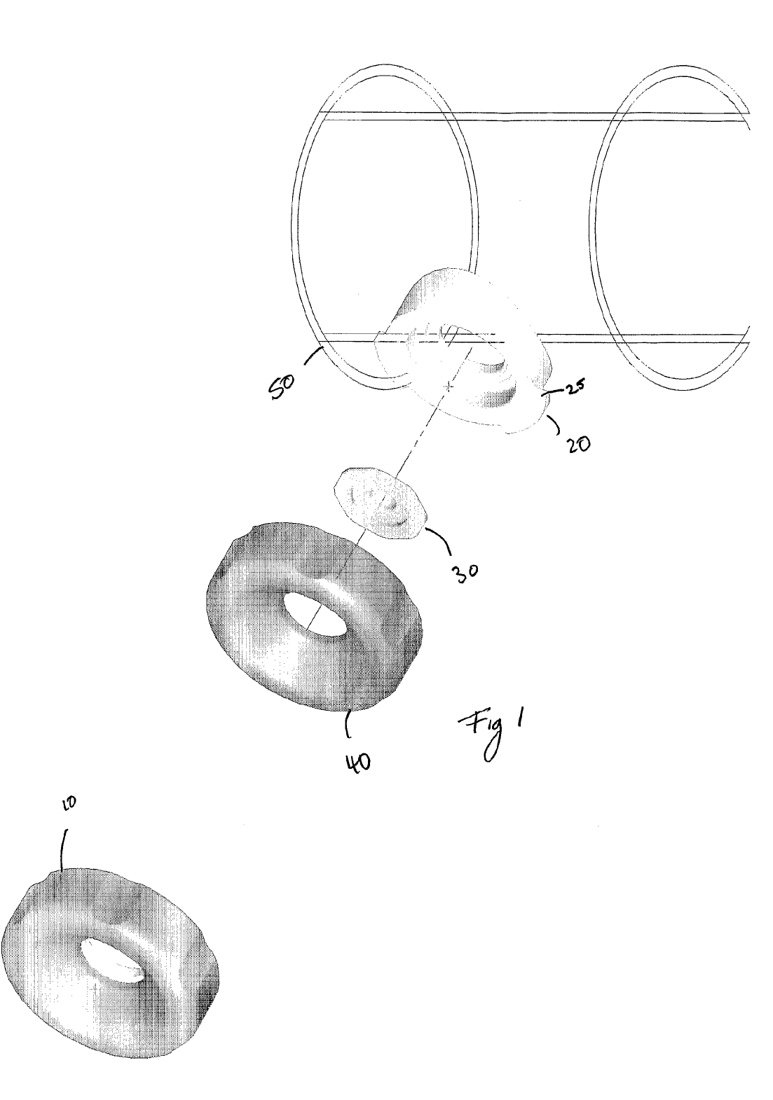

FIG. 2 Shows an exploded diagram of the components of the nozzle system from the perspective of the base component;

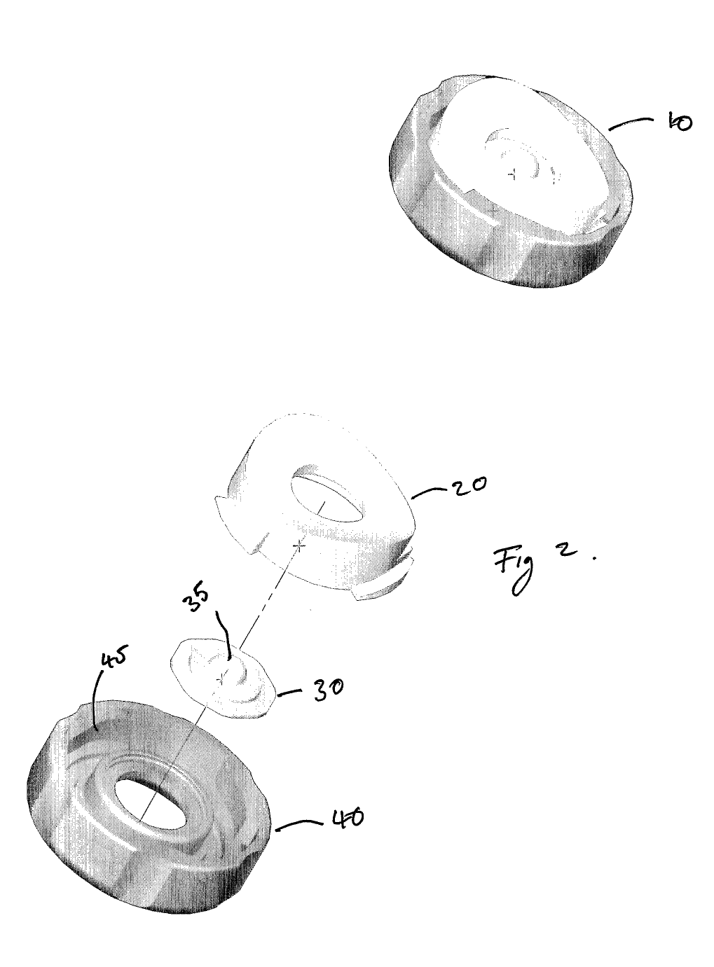

### DESCRIPTION OF AN EMBODIMENT OF THE INVENTION

In one embodiment of the invention the nozzle assembly 10 utilises a pressed disc shaped nozzle 30 with a convex nipple 35 which contains an orifice, and which protrudes up into and past the internal diameter of the spray pipe 50 it is mounted to.

The invention provides for the disc 30 to be mounted to a spray pipe 50 between a base component 20 and a cap component 40 which can be attached to each other manually by bayonet type fittings in the form of triangulated male lugs 25 on the base component 20 which cooperate with receptors 45 in the cap component 40.

The base component 20 may be welded to the header spray pipe 50 however alternate means of attachment may include cable ties and spring clips and the like as any appropriate attachment means may be used.

An O ring is provided between the disc member 30 and base component 20 in ordere to provide a sealing means. A further O ring is provided in an internal periphery of the cap so that when the nozzle system is connected that O ring is partially compressed and the system is locked by the resulting compressive forces between the lugs and receptors.

It is thus a simple matter to assemble and disassemble these components without tools by merely twisting the cap.

Both the base and cap components are provided with apertures therethrough and the base component is provided with a centrally oriented seat into which the periphery of the shower disc may be seated. The nozzle is therefor installed when the cap is twisted down onto the base component.

This arrangement obviates the need for tools and also reduces the possibility of any machine or external vibration causing the cap to disengage.

In addition the lugs and receptors are dimensioned such that the system can be connected in one orientation only which prevents the nozzle disc from spraying in a wrong plane.

The invention provides smooth external design which impedes the build up of debris and the like. In addition the wide open interior design allows wider spray patterns to spray out of the fitting uninterrupted.

The system of the invention allows for easy disassembly thereby reducing maintenance time significantly and also the use of the three bayonet type engagement means has the effect that there are no screw threads which may become damaged as in other systems.

The invention provides a simple unitary assembled piece which can be assembled with ease without tools.

While in this embodiment of the invention three retaining clasps are preferred the invention is not restricted in this regard and any appropriate materials may be used. In addition either male or female lugs could be used on either the cap or base.

Whilst we have described herein one specific embodiment of the invention it is envisaged that other embodiments of the invention will exhibit any number of and any combination of the features previously described and it is to be understood that variations and modifications in this can be made without departing from the spirit and scope of the invention.

1-9. (canceled)

10. A nozzle system, comprising:
a first component connected to a spray pipe, said first component being a base component and having a central aperture;
a shower disc having a nipple;
a second component being a cap component and having a central aperture; and,
means for manually engaging said base component with said cap component for compressively holding said shower disc between said base component and said cap component with said nipple of said shower disc extending into the spray pipe, when said nozzle system is assembled.

11. The nozzle system according to claim 10, wherein said first component is connected to the spray pipe via removable connecting means.

12. The nozzle system according to claim 10, wherein said means for manually engaging said base component with said cap component includes lugs located on said base component and receptors in said cap component.

13. The nozzle system according to claim 10, wherein said means for manually engaging said base component with said cap component includes lugs located on said cap component and receptors in said base component.

14. The nozzle system according to claim 10, further comprising an O-ring between said base component and said cap component for providing compression between said base component and said cap component for causing said nozzle system to lock when said base component and said cap component are connected.
